(19) United States
(12) Patent Application Publication
(10) Pub. No.: US 2024/0246834 A1
(43) Pub. Date: Jul. 25, 2024

(54) PURE WATER PRODUCTION APPARATUS AND PURE WATER PRODUCTION METHOD

(71) Applicant: ORGANO CORPORATION, Tokyo (JP)

(72) Inventors: Yusuke TAKAHASHI, Tokyo (JP); Kazushige TAKAHASHI, Tokyo (JP)

(73) Assignee: ORGANO CORPORATION, Tokyo (JP)

(21) Appl. No.: 18/289,910

(22) PCT Filed: Jan. 28, 2022
(86) PCT No.: PCT/JP2022/003220

§ 371 Date: Nov. 8, 2023

(30) Foreign Application Priority Data
May 12, 2021 (JP) 2021-080873

(51) Int. Cl. C02F 1/00; C02F 1/20; C02F 1/28; C02F 1/32; C02F 1/42; C02F 1/44; C02F 1/72; C02F 9/00; C02F 101/10; C02F 101/30

(52) U.S. Cl. CPC C02F 1/008; C02F 9/00; C02F 1/20; C02F 1/283; C02F 1/32; C02F 1/42; C02F 2001/422; C02F 2001/425; C02F 1/441; C02F 1/727; C02F 2101/10; C02F 2101/30; C02F 2209/20; C02F 2209/22

(57) ABSTRACT

A pure water production apparatus has a ultraviolet ray radiation apparatus that irradiates water to be treated with ultraviolet rays; a TOC acquisition unit and a dissolved oxygen concentration acquisition unit that are provided upstream of the ultraviolet ray radiation apparatus; and a control means that controls concentration of dissolved oxygen in the water to be treated that is supplied to the ultraviolet ray radiation apparatus such that a mass ratio of the concentration of dissolved oxygen in the water to be treated that is acquired by the dissolved oxygen concentration acquisition unit to TOC in the water to be treated that is acquired by the TOC acquisition unit is 1 or more and 7 or less.

### FIELD OF THE INVENTION

The present application is based on, and claims priority from, JP2021-80873, filed on May 12, 2021, the disclosure of which is hereby incorporated by reference herein in its entirety.

The present invention relates to a pure water production apparatus and a pure water production method, and particularly relates to a pure water production apparatus that uses an ultraviolet ray radiation apparatus.

### DESCRIPTION OF THE RELATED ART

A technique for decomposing organic materials to reduce TOC (Total Organic Carbon) in water to be treated is known. JP2011-218248 discloses a pure water production apparatus that has an apparatus for adding hydrogen peroxide and an ultraviolet ray radiation apparatus that is provided downstream thereof. Highly oxidative OH radicals are generated by irradiating with ultraviolet rays the water to be treated to which hydrogen peroxide has been added. Thus, organic materials in the water to be treated can be efficiently decomposed.

### SUMMARY OF THE INVENTION

In the pure water production apparatus described in JP2011-218248, hydrogen peroxide remains in the water to be treated which has been irradiated with ultraviolet rays, that is, the treated water of the ultraviolet ray radiation apparatus. Residual hydrogen peroxide may damage downstream apparatuses. Thus, frequent maintenance of the downstream apparatuses or means for removing hydrogen peroxide is required.

The present invention aims at providing a pure water production apparatus that can reduce TOC in water to be treated without adding an oxidizing agent such as hydrogen peroxide.

A pure water production apparatus of the invention comprises: an ultraviolet ray radiation apparatus that irradiates water to be treated with ultraviolet rays; a TOC acquisition unit and a dissolved oxygen concentration acquisition unit that are provided upstream of the ultraviolet ray radiation apparatus; and control means that controls concentration of dissolved oxygen in the water to be treated that is supplied to the ultraviolet ray radiation apparatus such that a mass ratio of the concentration of dissolved oxygen in the water to be treated that is acquired by the dissolved oxygen concentration acquisition unit to TOC in the water to be treated that is acquired by the TOC acquisition unit is 1 or more and 7 or less.

According to the present invention, it is possible to provide a pure water production apparatus that can reduce TOC in water to be treated without adding an oxidizing agent such as hydrogen peroxide.

The above and other objects, features, and advantages of the present invention will become apparent from the following description with reference to the accompanying drawings that illustrate examples of the present invention.

### BRIEF DESCRIPTION OF DRAWINGS

FIG. 1A is a view schematically illustrating the configuration of a pure water production apparatus according to an embodiment of the present invention;

FIG. 1B is a view schematically illustrating the configuration of a pure water production apparatus according to a modification of the present invention;

FIG. 2A is a graph showing the relationship between the DO/TOC ratio and the TOC removal rate; and

FIG. 2B is a graph showing the relationship between the DO/TOC ratio and the reduction rate of the concentration of dissolved oxygen.

### DESCRIPTION OF EMBODIMENTS

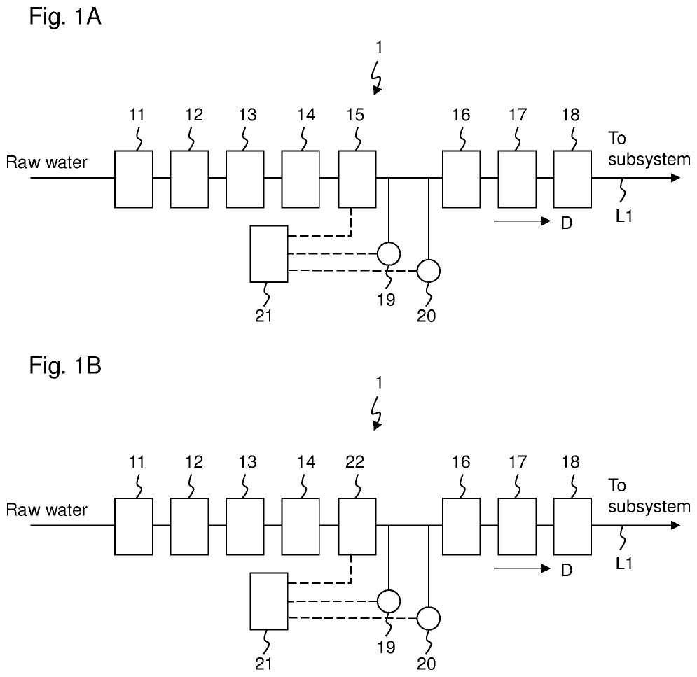

A pure water production apparatus and a pure water production method according to an embodiment of the present invention will be described with reference to the drawings. FIG. 1A schematically illustrates the configuration of pure water production apparatus 1 according to an embodiment of the present invention. Pure water production apparatus 1 (a primary system) constitutes an ultrapure water production apparatus together with a downstream subsystem (a secondary system). Raw water that is supplied to pure water production apparatus 1 (hereinafter, referred to as “water to be treated”) contains organic materials. In the following descriptions, “upstream” and “downstream” mean “upstream side” and “downstream side,” respectively, in the direction in which the water to be treated flows.

Pure water production apparatus 1 has filter membrane 11, activated carbon tower 12, first ion exchange apparatus 13, reverse osmosis membrane apparatus 14, deoxidization apparatus 15, ultraviolet ray radiation apparatus (ultraviolet ray oxidization apparatus) 16, second ion exchange apparatus 17, and deaerator apparatus 18, and these apparatuses are arranged along main line L1 in a series in the order listed above from upstream to downstream in water flow direction D of the water to be treated. The water to be treated is pressurized by a raw water pump (not illustrated), and thereafter dust and the like having relatively large diameters are removed by filter membrane 11, and impurities such as high-molecular organic materials are removed by activated carbon tower 12. The arrangement of filter membrane 11 is not limited, but a sand filter is used in the present embodiment. First ion exchange apparatus 13 has a cation tower (not illustrated) in which cation exchange resin is loaded, a decarbonation tower (not illustrated), and an anion tower (not illustrated) in which anion exchange resin is loaded, and these towers are arranged in a series in the order listed above from upstream to downstream. Cation components are removed by the cation tower, carbonic acid is removed by the decarbonation tower, and anion components are removed by the anion tower from the water to be treated. Reverse osmosis membrane apparatus 14 mainly removes nonionic materials such as organic materials because first ion exchange apparatus 13 is provided upstream thereof. The load on the downstream ultraviolet ray radiation apparatus 16 is reduced by removing the organic materials using reverse osmosis membrane apparatus 14. If the TOC in the water to be treated is high, then the TOC reduction rate of ultraviolet ray radiation apparatus 16 decreases.

Deoxidization means 15 removes oxygen from the water to be treated and reduces the concentration of dissolved oxygen in the water to be treated. Since deoxidization means 15 is positioned upstream of ultraviolet ray radiation apparatus 16, water to be treated having a reduced concentration of dissolved oxygen is supplied to ultraviolet ray radiation apparatus 16. The type of deoxidization means 15 is not limited, and for example, a vacuum deaerator apparatus may be used. In a typical vacuum deaerator apparatus, a gas-liquid contact element for increasing the surface area of water is loaded in a deaeration tower and the deaeration tower is depressurized by a vacuum pump to place pure water, which is the water to be treated, in a vacuum to thereby remove dissolved oxygen. The concentration of dissolved oxygen can be controlled by adjusting the degree of vacuum in the deaeration tower by means of the vacuum pump. In addition, the deaeration performance can be improved by introducing nitrogen. In this case, the concentration of dissolved oxygen can be controlled by adjusting the degree of vacuum and the amount of the introduced nitrogen (the partial pressure of nitrogen). Deoxidization means 15 that uses a deaeration membrane may also be used. In this case, a vacuum pump is used as in the vacuum deaerator apparatus, and the concentration of dissolved oxygen can be controlled by adjusting the degree of vacuum. Two or more deoxidization means 15 may be provided in a series. As another type of deoxidization means 15, an arrangement in which hydrogen (H₂) is added to the water to be treated and the water to be treated comes into contact with a palladium (Pd) catalyst may be used. The palladium catalyst causes oxygen to react with hydrogen to form water, whereby oxygen can be removed. Alternatively, ion exchangers that carry metal catalyst such as palladium may be loaded in an electro-deionization apparatus (EDI). The hydrogen that comes into contact with the metal catalyst may be, for example, hydrogen that is generated by the cathode of the electro-deionization apparatus. By using these types of deoxidization means 15, water to be treated that contains organic materials and dissolved oxygen and in which the concentration of dissolved oxygen has been adjusted is supplied to ultraviolet ray radiation apparatus 16. On the other hand, since an oxidizing agent such as hydrogen peroxide is not added to the water to be treated, the water to be treated that is supplied to ultraviolet ray radiation apparatus 16 does not contain an oxidizing agent. In other words, pure water production apparatus 1 does not have means for adding an oxidizing agent. As a result, there is no need for a facility for consuming or removing an oxidizing agent that has been added, and pure water production apparatus 1 can be simplified. It should be noted that minute amounts of oxidizing components that originate from the raw water may be included in the water to be treated.

Ultraviolet ray radiation apparatus 16 irradiates the water to be treated with ultraviolet rays. Ultraviolet ray radiation apparatus 16 may have an ultraviolet ray lamp that includes a wavelength of, for example, at least any one of 365 nm, 254 nm, 185 nm, and 172 nm.

Second ion exchange apparatus 17 that is positioned downstream of ultraviolet ray radiation apparatus 16 is a regenerative ion exchange resin tower in which anion exchange resin and cation exchange resin are loaded. Decomposition products of the organic materials that are generated in the water to be treated by the irradiation of ultraviolet rays are removed by second ion exchange apparatus 17. Thereafter, dissolved oxygen, carbonic acid, and the like in the water to be treated are removed by deaerator apparatus 18. Although not illustrated, it is also possible to omit first ion exchange apparatus 13 and to provide an EDI between reverse osmosis membrane apparatus 14 and deoxidization apparatus 15. Alternatively, an EDI may be provided instead of second ion exchange apparatus 17. An EDI does not require a regeneration process for ion exchangers because an EDI continuously regenerates ion exchangers.

In the present embodiment, TOC acquisition unit 19 and dissolved oxygen concentration acquisition unit 20 are provided upstream of ultraviolet ray radiation apparatus 16. TOC acquisition unit 19 and dissolved oxygen concentration acquisition unit 20 are provided in the section of main line L1 between deoxidization apparatus 15 and ultraviolet ray radiation apparatus 16. Either of TOC acquisition unit 19 and dissolved oxygen concentration acquisition unit 20 may be positioned on the upstream side. TOC acquisition unit 19 and dissolved oxygen concentration acquisition unit 20 are electrically connected to control means 21, and control means 21 is electrically connected to deoxidization apparatus 15. In the present embodiment, TOC acquisition unit 19 is a TOC meter but is not limited to this device as long as it can acquire the TOC. Similarly, in the present embodiment, dissolved oxygen concentration acquisition unit 20 is a dissolved oxygen concentration meter but is not limited to this device as long as it can acquire the concentration of dissolved oxygen.

Control means 21 controls the concentration of dissolved oxygen such that the mass ratio of the concentration of dissolved oxygen in the water to be treated that is measured by dissolved oxygen concentration acquisition unit 20 to the TOC in the water to be treated that is measured by TOC acquisition unit 19 (hereinafter, referred to as the DO/TOC ratio) is 1 or more and 7 or less. Control means 21 is desirably incorporated into a control unit of pure water production apparatus 1 or into a control unit of deoxidization apparatus 15. Although the DO/TOC ratio depends on the TOC, the DO/TOC ratio of the water to be treated is typically much higher than the above-mentioned numeral range. In other words, the water to be treated contains a much larger amount of dissolved oxygen than an amount that satisfies the DO/TOC ratio=1 to 7. For this reason, deoxidization apparatus 15 is provided upstream of ultraviolet ray radiation apparatus 16 in the present embodiment, but conversely, there is the possibility that the concentration of dissolved oxygen in the water to be treated is extremely low and that the DO/TOC ratio is less than 1. In this case, oxygen is preferably supplied to the water to be treated. Accordingly, oxygen supply means 22 may be provided depending on the DO/TOC ratio of the water to be treated. As shown in FIG. 1B, deoxidization apparatus 15 is omitted and oxygen supply means 22 is provided in its place. Although not illustrated, it is also possible to arrange deoxidization apparatus 15 and oxygen supply means 22 in parallel and to switch between them depending on the DO/TOC ratio. Examples of oxygen supply means 22 include an arrangement in which oxygen gas is added to the water to be treated via a gas dissolving membrane. Deoxidization apparatus 15 and oxygen supply means 22 are examples of means for adjusting the concentration of dissolved oxygen, and control means 21 controls the means for adjusting the concentration of dissolved oxygen. Control means 21 desirably automatically controls the degree of vacuum and the partial pressure of nitrogen mentioned above depending on either one or both of the variation of the TOC in the water to be treated that is measured by TOC acquisition unit 19 and the variation of the concentration of dissolved oxygen in the water to be treated that is measured by dissolved oxygen concentration acquisition unit 20. The concentration of dissolved oxygen may also be controlled by increasing or decreasing the number of deoxidization apparatuses 15.

When water that contains dissolved oxygen is irradiated with ultraviolet rays, the following reaction is assumed to occur:

$$2 {H}_{2} O + 1 / 2 {O}_{2} ⇄ 2 \cdot H + 2 \cdot OH + 1 / 2 {O}_{2} \to {H}_{2} O + 2 \cdot OH \qquad ( Formula 1 )$$

Specifically, dissociated hydrogen radicals (•H) react with dissolved oxygen to form water, and residual OH radicals (•OH) decompose organic materials. A certain amount of dissolved oxygen is required to efficiently decompose organic materials with this reaction. As will be described later, the necessary amount of dissolved oxygen can be secured by setting the DO/TOC ratio to 1 or more. On the other hand, as mentioned above, raw water typically contains an excessive amount of dissolved oxygen and deoxidization apparatus 15 is therefore provided upstream of ultraviolet ray radiation apparatus 1. However, the reduction of the DO/TOC ratio may require an increase in the size of deoxidization apparatus 15 or may result in an increase in the consumption of electric power. As will be described in the Example, the effect of reducing the TOC does not change greatly in proximity to a DO/TOC ratio of 1. Further, when the DO/TOC ratio exceeds 7, the efficiency of decomposing organic materials is reduced and the TOC removal rate is impaired. In addition, the load upon deaerator apparatus 18 for the removal of residual dissolved oxygen is increased. The impairment of the TOC removal rate is due to the absorption of ultraviolet rays by O₂. Therefore, when the concentration of dissolved oxygen is too high, the amount of OH radicals that are generated decreases and the efficiency of decomposing organic materials is reduced.

When dissolved oxygen is efficiently consumed, the residual dissolved oxygen decreases and the load on deaerator apparatus 18 is reduced. Accordingly, the consumption rate of dissolved oxygen in ultraviolet ray radiation apparatus 16 is important as an indication of the performance of pure water production apparatus 1. The consumption rate of dissolved oxygen can be enhanced by setting the DO/TOC ratio to 1 or more and 7 or less. Based on the foregoing, the DO/TOC ratio is preferably set to 2 or more and 7 or less, and more preferably, the consumption rate of dissolved oxygen is set to 90% or more.

### EXAMPLES

Water to be treated was prepared by adding oxygen and organic materials to ultrapure water. The water to be treated was irradiated with ultraviolet rays, and the organic material removal performance (the performance of reducing the TOC) was evaluated. As the organic materials, 10 μg/L (ppb) of isopropyl alcohol (IPA) was added (Example 1). Dissolved oxygen was produced by supplying oxygen gas to the ultrapure water via a dissolving membrane. The water to be treated thus prepared was supplied to an ultraviolet ray radiation apparatus at a flow rate of 5.3 m³/h. As the ultraviolet ray radiation apparatus, JPW (manufactured by Photoscience Japan Corporation) was used and the water to be treated was irradiated with ultraviolet rays at a radiation intensity of 0.1 kWh/m³. A column in which cation exchange resin (AMBERJET 1024H manufactured by Organo Corporation) and anion exchange resin (AMBERJET 4002OH manufactured by Organo Corporation) were loaded in a mixed bed was provided downstream of the ultraviolet ray radiation apparatus, and ion components contained in the treated water of the ultraviolet ray radiation apparatus were removed. TOC T1 at the inlet of the ultraviolet ray radiation apparatus and TOC T2 at the outlet of the column were measured by means of Sievers TOC meters 500RLe (manufactured by SUEZ), and the TOC removal rate was calculated as (T1−T2)/T1×100 (%). Further, the concentration of dissolved oxygen D1 in the water supplied to ultraviolet ray radiation apparatus 16 and the concentration of dissolved oxygen D2 in the treated water of ultraviolet ray radiation apparatus 16 were measured by means of ORBISPHERE 510 manufactured by HACH, and the consumption rate of dissolved oxygen was calculated as (D1−D2)/D1×100 (%).

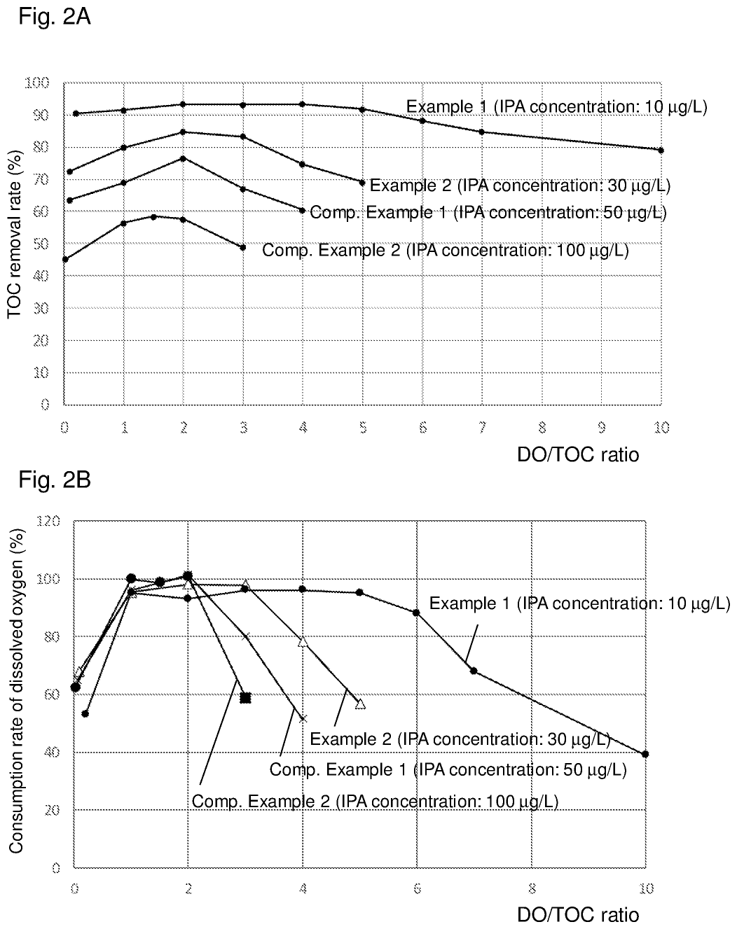

The relationship between the DO/TOC ratio and the TOC removal rate and the relationship between the DO/TOC ratio and the consumption rate of dissolved oxygen were obtained for various concentrations of dissolved oxygen. The same measurements were made for various amounts of added IPA, that is, 30 μg/L, 50 μg/L, and 100 μg/L (Example 2, Comparative Examples 1 and 2). The results are shown in Table 1, FIG. 2A and FIG. 2B. FIG. 2A shows that the TOC removal rate improved as the TOC (the concentration of IPA) in the water to be treated decreased. In Example 1, the TOC removal rate when the DO/TOC ratio=1 to 5 was improved as compared with the TOC removal rate when the DO/TOC ratio=0.2. The TOC removal rate was particularly good when the DO/TOC ratio=2 to 4. The TOC removal rate slightly decreased when the DO/TOC ratio=7, but since the load on deoxidization apparatus 15 was reduced, this ratio may be a practical level depending on the required water quality or operation conditions. As shown in FIG. 2B, the consumption rate of dissolved oxygen was 90% or more when the DO/TOC ratio=1 to 5, and the consumption rate when the DO/TOC ratio=7 was better than the consumption rate when the DO/TOC ratio=0.2. On the other hand, reducing the concentration of dissolved oxygen such that the DO/TOC ratio <1 greatly affects the facility cost such as an increase in the number or capacity of deoxidization apparatuses 15. In light of the facility cost, it is not preferable to set the DO/TOC ratio to less than 1 and is preferable to set the DO/TOC ratio to 1 or more. Accordingly, in the case of 10 μg/L or less, the DO/TOC ratio is preferably 1 or more and 7 or less, more preferably 2 or more and 7 or less, still more preferably 2 or more and 5 or less, and yet still more preferably 2 or more and 4 or less. Control means 21 preferably controls the concentration of dissolved oxygen to obtain these ranges of the DO/TOC ratio.

In Example 2, the TOC removal rate decreased compared to Example 1 but showed the same tendency as Example 1. However, the TOC removal rate greatly varied according to the DO/TOC ratio compared to Example 1, and the preferable range of the DO/TOC ratio was narrower than in Example 1. The consumption rate of dissolved oxygen when DO/TOC ratio=1 to 4 was better than the consumption rate when the DO/TOC ratio=0.1, and the consumption rate decreased when the DO/TOC ratio=5. However, the consumption rate of dissolved oxygen when the DO/TOC ratio=5 was not greatly different from the consumption rate of dissolved oxygen when the DO/TOC ratio=0.1. As mentioned above, it is not preferable to set the DO/TOC ratio to less than 1 and is advantageous to set the DO/TOC ratio to 1 or more. Accordingly, when the TOC in the water to be treated is 30 μg/L or less, control means 21 preferably controls the concentration of dissolved oxygen such that the DO/TOC ratio is 1 or more and 5 or less, preferably 2 or more and 5 or less, and more preferably 2 or more and 4 or less. On the other hand, in Comparative Examples 1 and 2, the TOC removal rate was low and the DO/TOC ratio showing a preferable range of the consumption rate of dissolved oxygen and consumption rate of dissolved oxygen was narrow.

TABLE 1

| | | | | Outlet of | |
|---|---|---|---|---|---|
| | Inlet of ultraviolet ray | | | Ultraviolet | Outlet |
| | radiation apparatus | | | ray radiation | of |
| | Concen- | | | apparatus | column |
| | tration of | | | Consumption rate | TOC |
| Example/ | dissolved | | | of dissolved | removal |
| Comp. | oxygen | IPA | DO/ | oxygen | rate |
| Example | (mg/L) | (mg/L) | TOC | (%) | (%) |
| Example 1 | 2 | 10 | 0.2 | 53 | 90 |
| | 10 | | 1 | 95 | 91 |
| | 20 | | 2 | 93 | 93 |
| | 30 | | 3 | 96 | 93 |
| | 40 | | 4 | 96 | 93 |
| | 50 | | 5 | 95 | 92 |
| | 60 | | 6 | 88 | 88 |
| | 70 | | 7 | 68 | 85 |
| | 100 | | 10 | 39 | 79 |
| | 1000 | | 100 | 3 | 66 |
| Example 2 | 3 | 30 | 0.1 | 68 | 73 |
| | 30 | | 1 | 95 | 80 |
| | 60 | | 2 | 98 | 85 |
| | 90 | | 3 | 98 | 83 |
| | 120 | | 4 | 78 | 75 |
| | 150 | | 5 | 57 | 69 |
| Comp. | 3 | 50 | 0.1 | 65 | 64 |
| Example 1 | 50 | | 1 | 96 | 69 |
| | 100 | | 2 | 101 | 77 |
| | 150 | | 3 | 80 | 67 |
| | 200 | | 4 | 52 | 60 |
| Comp. | 2 | 100 | 0.02 | 62 | 45 |
| Example 2 | 100 | | 1 | 100 | 56 |
| | 150 | | 1.5 | 99 | 58 |
| | 200 | | 2 | 101 | 58 |
| | 300 | | 3 | 59 | 49 |

Although certain preferred embodiments of the present invention have been shown and described in detail, it should be understood that various changes and modifications may be made without departing from the spirit or scope of the appended claims.

### LIST OF REFERENCE NUMERALS

1 Pure water production apparatus
15 Deoxidization means
16 Ultraviolet ray radiation apparatus
19 TOC acquisition unit
20 Dissolved oxygen concentration acquisition unit
21 Control means
22 Oxygen supply means

1. A pure water production apparatus comprising:
an ultraviolet ray radiation apparatus that irradiates water to be treated with ultraviolet rays;
a TOC acquisition unit and a dissolved oxygen concentration acquisition unit that are provided upstream of the ultraviolet ray radiation apparatus; and
control means that controls concentration of dissolved oxygen in the water to be treated that is supplied to the ultraviolet ray radiation apparatus such that a mass ratio of the concentration of dissolved oxygen in the water to be treated that is acquired by the dissolved oxygen concentration acquisition unit to TOC in the water to be treated that is acquired by the TOC acquisition unit is 1 or more and 7 or less.

2. The pure water production apparatus according to claim 1, wherein the control means controls the concentration of dissolved oxygen in the water to be treated that is supplied to the ultraviolet ray radiation apparatus such that the mass ratio is 2 or more and 7 or less.

3. The pure water production apparatus according to claim 1, wherein the TOC in the water to be treated that is supplied to the ultraviolet ray radiation apparatus is 10 μg/L or less.

4. The pure water production apparatus according to claim 3, wherein the control means controls the concentration of dissolved oxygen in the water to be treated that is supplied to the ultraviolet ray radiation apparatus such that the mass ratio is 2 or more and 5 or less.

5. The pure water production apparatus according to claim 1, wherein the control means controls the concentration of dissolved oxygen in the water to be treated that is supplied to the ultraviolet ray radiation apparatus such that a consumption rate of dissolved oxygen of the ultraviolet ray radiation apparatus is 90% or more.

6. The pure water production apparatus according to claim 1, further comprising deoxidization means that is positioned upstream of the dissolved oxygen concentration acquisition unit and the ultraviolet ray radiation apparatus.

7. The pure water production apparatus according to claim 6, wherein the deoxidization means is a deaerator apparatus, and the concentration of dissolved oxygen is controlled by adjusting a degree of vacuum in the deaerator apparatus.

8. The pure water production apparatus according to claim 1, further comprising oxygen supply means that is positioned upstream of the dissolved oxygen concentration acquisition unit and the ultraviolet ray radiation apparatus.

9. The pure water production apparatus according to claim 1, wherein no oxidizing agent is added to the water to be treated that is supplied to the ultraviolet ray radiation apparatus.

10. A pure water production method comprising:
using a TOC acquisition unit to measure TOC and using a dissolved oxygen concentration acquisition unit to measure concentration of dissolved oxygen in water to be treated upstream of an ultraviolet ray radiation apparatus;
using the ultraviolet ray radiation apparatus to irradiate the water to be treated with ultraviolet rays, wherein the TOC and the concentration of dissolved oxygen in the water to be treated have been measured; and
controlling the concentration of dissolved oxygen such that a mass ratio of the concentration of dissolved oxygen in the water to be treated that is acquired by the dissolved oxygen concentration acquisition unit to the TOC in the water to be treated that is acquired by the TOC acquisition unit is 1 or more and 7 or less.
